(19) United States
(12) Patent Application Publication
(10) Pub. No.: US 2010/0270858 A1
(43) Pub. Date: Oct. 28, 2010

(54) DEVICE AND METHOD FOR GENERATING A BACK-UP ELECTRICITY SUPPLY ON BOARD AN AIRCRAFT

(75) Inventors: Etienne Foch, Toulouse (FR); Olivier Langlois, Colomiers (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: AIRBUS FRANCE, TOULOUSE (FR)

(21) Appl. No.: 12/294,246

(22) PCT Filed: Mar. 7, 2007
(86) PCT No.: PCT/EP07/52140

§ 371 Date: Sep. 24, 2008

(30) Foreign Application Priority Data
Apr. 4, 2006 (FR) 0651186

(51) Int. Cl. B60L 1/00

(52) U.S. Cl. 307/9.1

(57) ABSTRACT

A device and a method to generate electricity on board an aircraft, including plural generators and plural air-conditioning units having an outside air intake. This device includes a control to command air-conditioning units as emergency generators and a storage device.

### TECHNICAL AREA

The invention concerns a device and a method to generate emergency electrical power on board on aircraft e.g. an airplane.

### STATE OF THE PRIOR ART

Following after the <<more electric>> airplane, the <<all-electric>> airplane entails numerous changes compared with current airplanes. The elimination of use of bleed air from the engines used inter alia for cockpit and cabin air-conditioning, brings a major change. This elimination involves the need to ensure said air-conditioning of the cockpit and cabin from electricity available on board, in line with the notion of a more electric airplane.

To provide this air-conditioning, which requires very high electric power, in the order of that currently available on civil passenger aircraft, four separate motors can be used to drive air compressors.

A simplified architecture of an electrical power system in an all-electric airplane with a conventional device for emergency power supply is illustrated on FIG. 1.

This architecture has primary electricity generation in three-phase (AC) alternating current (e.g. 230/400 volts AC) and mixed distribution with high voltage direct current (e.g. +/−270 volts DC).

In this architecture, primary electricity generation is supplied by four generators GEN1, GEN2, GEN3 and GEN4 each supplying a bus bar for three-phase 230 volts AC electric distribution, these bars being referenced 10, 11, 12, 13.

The generation of high voltage direct current of +/−270 volts DC (bus bars referenced 15, 16, 17, 18) is obtained by rectifying the preceding alternating voltage e.g. using rectifying auto-transformer units ATRU1, ATRU2, ATRU3 and ATRU4.

The units of the air-conditioning system ECS1, ECS2, ECS3, ECS4 are supplied with high voltage direct current via voltage inverters MC1, MC2, MC3 and MC4.

This airplane electrical circuit system therefore comprises four fully segregated areas 20, 21, et 23 providing for improved electricity availability on board the airplane in the event of a failure.

The <<essential>> part of the circuit (critical loads 25) is connected to an <<essential>> high voltage direct current bus bar +/−270 volts DC, 26. As illustrated on FIG. 1, this bus bar 26 is normally supplied by the high voltage bus bar 15.

As illustrated on FIG. 2, in the event of loss of all primary electricity generation (GEN1, GEN2, GEN3, GEN4), an emergency generator EMER GEN is able to supply this essential bus bar 26. In this case, only the critical loads 25 of the circuit are supplied.

This emergency generator EMER GEN can be a Ram Air Turbine, or RAT, deployed underneath the airplane. In a <<more electric>> or <<all-electric>>, airplane, this turbine can drive an electric generator and thereby supply the critical loads of the emergency circuit.

Other generators of similar type can also be considered: for example turbines of APU type (Auxiliary Power Unit) which run on kerosene or hydrazine, fuel cells, etc.

The use of an emergency generator of ram air type has several disadvantages. It has non-negligible mass and volume. Its installation on the aircraft is restrictive since it must be positioned at a strategic point enabling it to be properly exposed to air: its level of performance is dependent thereupon. Poor positioning would lead to greater sizing and weight to obtain the same production of electricity. There are similar drawbacks with the use of any other emergency generator (APU, fuel cell, etc.).

A first transitory period exists during which the emergency electric power device is inoperative: from the moment the entire primary electricity generation is lost up until effective start-up of the emergency generator EMER GEN.

The start-up time of an emergency generator EMER GEN is effectively fairly long. It may exceed several seconds. During this transitory period between the time of loss of the primary generation and the start-up of this emergency generator, the critical loads do not receive any supply, which is unacceptable.

With a ram air turbine, a second transitory period may be observed on landing. Said turbine is effectively ineffective at low speed, after landing. Yet braking of an aircraft's wheels requires substantial electric power, which it is mandatory to be able to provide.

The purpose of the invention is to solve the technical problems connected with the use of a ram air turbine as emergency power source, and with the existence of said transitory periods.

### DESCRIPTION OF THE INVENTION

The invention concerns an electrical power device on board an aircraft e.g. an airplane, comprising several generators and several air-conditioning units having an outside air intake, characterized in that it includes means to command the air-conditioning units as emergency generators and a storage device.

Advantageously, it comprises an essential bus bar to which critical loads of the aircraft and the storage device are connected, and means to connect static converters, linked with the air-conditioning units, to the essential bus bar. This storage device may include several devices: storage batteries, super-capacitors, kinetic accumulators (inertia flywheels) etc. Advantageously the storage device comprises two separate sub-systems: one for +270 volts DC and one for −270 volts DC. Advantageously, the storage device uses electrochemical storage via storage batteries or super-capacitors, and comprises two storage sub-assemblies and two static DC/DC converters. Advantageously, the storage device comprises an active filtering function.

The invention also concerns a method to generate electricity on board an aircraft, e.g. an airplane, comprising several generators and several air-conditioning units having an outside air intake, characterized in that during normal operation the air-conditioning units are supplied with high voltage, and that during emergency functioning the air-conditioning units are used as emergency generators, and in that the supply of electricity is ensured during the transitory periods between normal functioning and emergency functioning and on airplane landing, by means of a storage device.

Advantageously, during normal functioning the air-conditioning units are supplied via static converters used as inverters, and during emergency functioning the air-conditioning units are used to supply an essential bus bar, on which the critical loads of the aircraft and the storage device are connected, via the static converters used as rectifiers.

The invention concerns an aircraft comprising the device such as defined above, and also an aircraft comprising a device able to implement the method such as defined above.

The invention provides numerous advantages and in particular the following advantages:
Use of the power reversibility of the air-conditioning units, and more particularly of the air compressors, allows use thereof as emergency generators. Given their high power, it is possible to consider the elimination of any other generator of RAT, APU, fuel cell type, etc. Savings in terms of space and weight are of interest.
The installing of a storage device ensures availability of the electrical power system during transient periods when the emergency generator is inactive. This function is of particular utility during the moments following after total failure of primary electricity generation and on aircraft landing.
The association of the storage device with the air-conditioning units allows various command strategies. Reconfigurations of the commands for each emergency generator enable good management of voltage quality and availability within the circuit. In addition, the storage device can be used in non-emergency mode as an active filter to improve voltage quality within the electrical circuit.
Use of the air-conditioning units can reduce the length of the transitory period following after failure of electric power generation. Since these units are already in service before occurrence of the failure, their rotating speeds are already high. The switching of these units from air compressor mode (normal functioning) over to generator mode (emergency functioning) is therefore almost instantaneous. This is not the case with emergency generators such as ram air turbines, APUs, fuel cells etc. . . . which require start-up.

### BRIEF DESCRIPTION OF THE DRAWINGS

FIGS. 1 and 2 illustrate a device on board an aircraft for emergency electricity generation known in the prior art, under normal functioning and emergency functioning respectively.

FIGS. 3 and 4 illustrate the emergency electricity generation device of the invention on board an aircraft, under normal functioning and under emergency functioning respectively.

### DETAILED DESCRIPTION OF PARTICULAR EMBODIMENTS

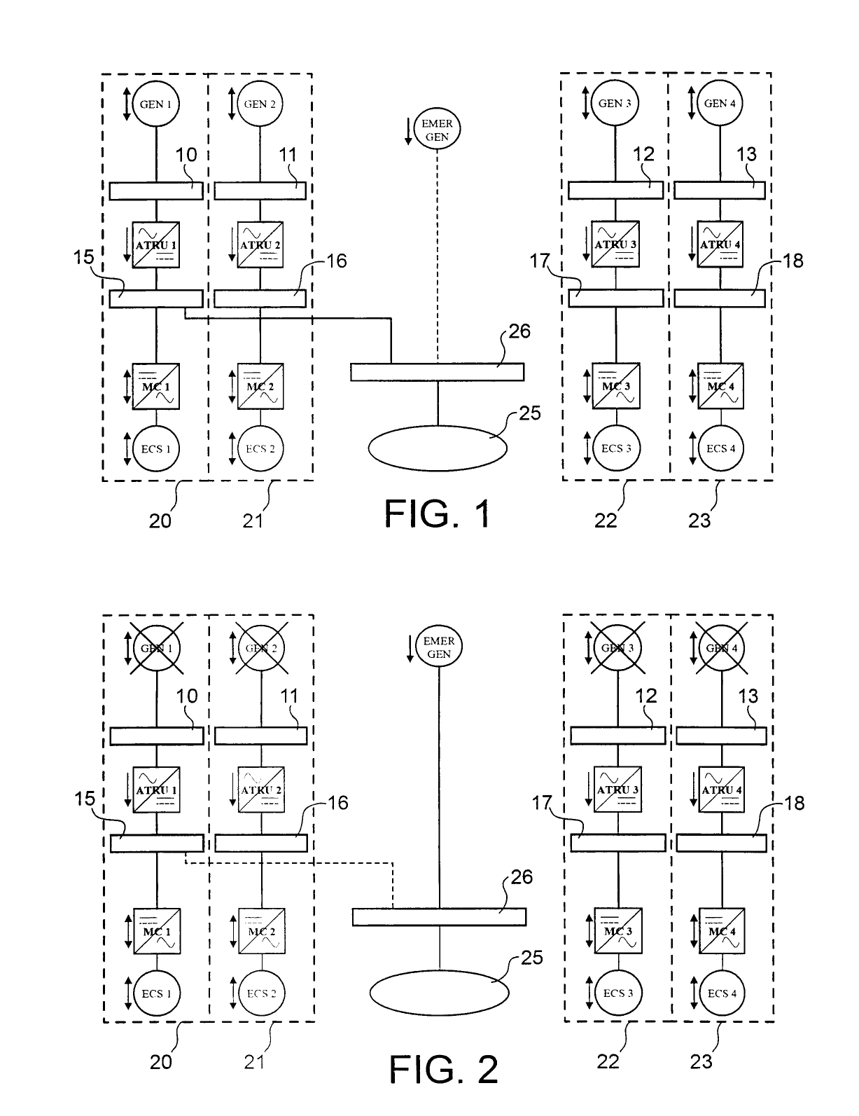

The device of the invention for emergency electricity generation offers an electric circuit architecture in which the air-conditioning units ECS1, ECS2, ECS3 et ECS4 illustrated on FIGS. 1 and 2 are used as emergency electricity generators.

In simplified terms, the air-conditioning units compress the air arriving from outside the airplane. In each unit an air compressor is driven by an electric rotating machine fed by a static converter MC used as inverter. The compressor has reversible power, i.e. it is possible to drive its mechanical shaft in rotation by injecting air onto its turbine. The electric rotating machine and the converter MC also have reversible power. According to the invention, each of the air-conditioning units, used as emergency electricity generator, supplies electricity to the electrical power circuit, for as long as the aircraft travels at sufficient speed.

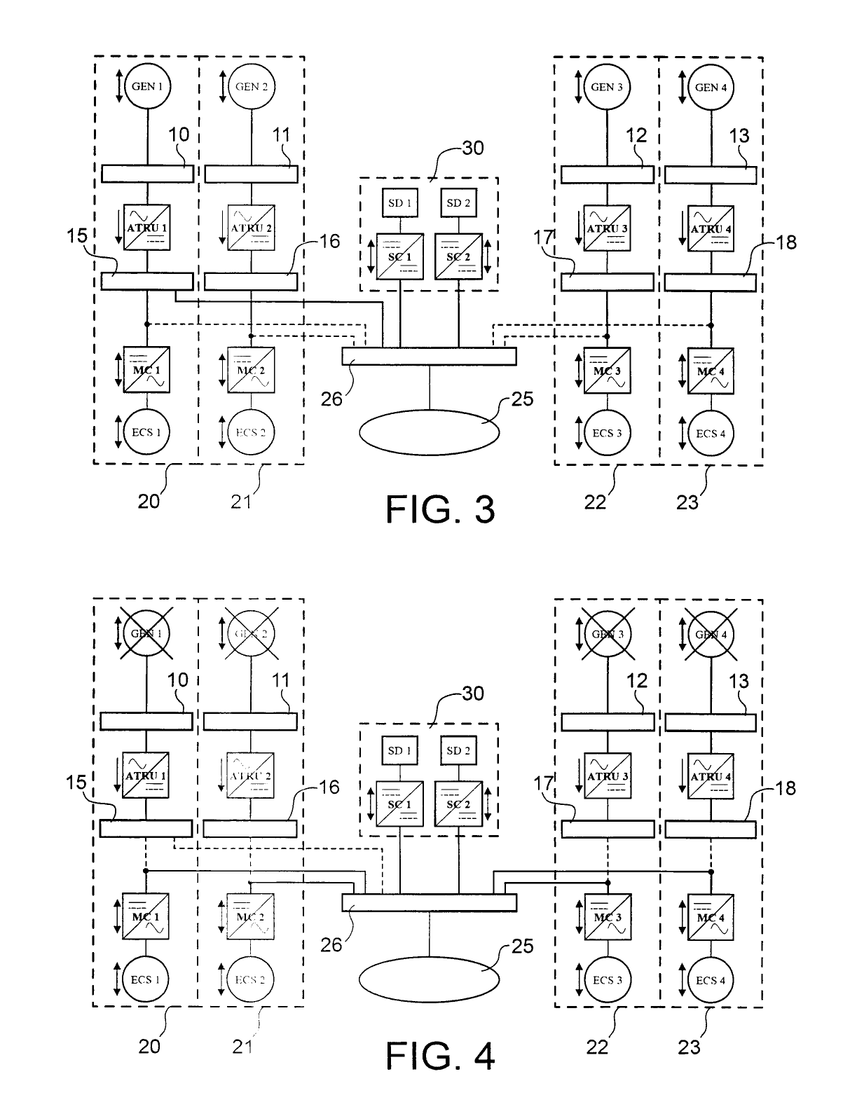

FIG. 3 therefore illustrates a simplified architecture of the electric circuit of an all-electric aircraft with emergency electricity being generated by these air-conditioning units ECS1, ECS2, ECS3 and ECS4, the elements already used in FIGS. 1 and 2 maintaining the same reference numbers.

As illustrated in this FIG. 3, under normal functioning, the air-conditioning units ECS1, ECS2, ECS3 and ECS4 are supplied by the bus bars 15, 16, 17 and 18.

As illustrated FIG. 4, under emergency functioning, the air-conditioning units ECS1, ECS2, ECS3 and ECS4 are used as emergency generators. The static converters MC1, MC2, MC3 and MC4 are disconnected from their initial bus bars 15, 16, 17 and 18. These converters are then coupled to the essential bus bar +/−270 volts DC, 26. These converters are then used as rectifiers and no longer as inverters.

Even if the yield of the units ECS1, ECS2, ECS3 and ECS4 is lower in emergency mode than in motor mode used for the air compressing function, it is possible on account of the high nominal power of each unit ECS1, ECS2, ECS3 and ECS4, to extract substantial power therefrom.

As illustrated in these FIGS. 3 and 4, at the time of switchover from normal mode to emergency mode, the very short transitory period needed for switching of the units ECS1, ECS2, ECS3 and ECS4 from motor mode to generator mode can be ensured by a storage device 30. This storage system, during landing of the aircraft, can ensure the supply of electricity required for braking of the aircraft. At this time, the speed of the aircraft is effectively too low to obtain sufficient power from the units ECS1, ECS2, ECS3 and ECS4.

Advantageously, this storage device consists of two separate storage sub-systems, one for +270 volts DC and one for −270 volts DC. These sub-systems are directly coupled to the essential bus bar 26. If storage is electrochemical via storage batteries or super-capacitors, this storage device 30 comprises two storage sub-assemblies SD1 et SD2 and two static converters SC1 and SC2.

This storage device 30 is permanently coupled to the electric circuit, even under normal functioning. In this way it can stay charged. It is therefore ready to intervene in the event of failure of primary electricity generation.

One function of interest of this storage device 30 is the possible absorption of power discharged by a reversible circuit load. An active filtering function can also be added to this storage device 30, with a view to improving the voltage quality in normal mode.

FIG. 4 illustrates the architecture of the electrical circuit in the event of emergency functioning with the units ECS1, ECS2, ECS3 and ECS4. One possible management strategy for these different units consists of allocating the regulation of circuit voltage to the storage sub-assemblies SD1 and SD2. The units ECS1, ECS2, ECS3 and ECS4 are then commanded so as to provide the current required by the critical loads 25. In this way, the storage sub-assemblies SD1 and SD2 allow good voltage quality to be maintained on the electrical circuit. In addition, they are therefore instantly operational when the units ECS1, ECS2, ECS3 and ECS4 are no longer able to provide substantial power on landing.

1-11. (canceled)

12. A device for electricity generation on board an aircraft, including plural generators and plural air-conditioning units having an outside air intake, the device comprising:
means to command air-conditioning units as emergency generators; and
a storage device.

13. A device according to claim 12, further comprising:
an essential bus bar on which critical loads of the aircraft and the storage device are connected; and
means to connect static converters, linked with the air-conditioning units, to the essential bus bar.

14. A device according to claim 12, wherein the storage device comprises storage batteries, super-capacitors, or kinetic accumulators.

15. A device according to claim 12, wherein the storage device comprises two separate sub-systems: one for +270 VDC and one for −270 VDC.

16. A device according to claim 12, wherein the storage device comprises two sub-assemblies and two static DC/DC converters.

17. A device according to claim 12, wherein the storage device comprises an active filtering function.

18. A device according to claim 12, in which the aircraft is an airplane.

19. A method to generate electricity on board an aircraft including plural generators and plural air-conditioning units having an outside air intake, the method comprising:
under normal functioning supplying the air-conditioning units with high voltage, and under emergency functioning using the air-conditioning units as emergency generators; and
ensuring supply of electricity, during transitory periods between normal functioning and emergency functioning and on landing of the aircraft, by a storage device.

20. A method according to claim 19, wherein under normal functioning the air-conditioning units are supplied via static converters used as inverters, and wherein under emergency functioning the air-conditioning units are used to supply an essential bus bar on which critical loads of the aircraft and the storage device are connected, via the static converters used as rectifiers.

21. An aircraft comprising a device according to claim 12.

22. An aircraft comprising a device configured to implement the method according to claim 14.
